(19) United States
(12) Patent Application Publication
(10) Pub. No.: US 2014/0190064 A1
(43) Pub. Date: Jul. 10, 2014

(54) CONVERTIBLE FISHING LURE

(71) Applicant: Russell Fellbaum, Swanville, MN (US)

(72) Inventor: Russell Fellbaum, Swanville, MN (US)

(21) Appl. No.: 13/736,874

(22) Filed: Jan. 8, 2013

(51) Int. Cl. A01K 85/00

(52) U.S. Cl. CPC A01K 85/00
USPC 43/42.09

(57) ABSTRACT

A fishing lure that easily and quickly converts from one look or character to another without tools and without untying the lure from the fishing line. A generally hollow body assembly is transparent to view an insert assembly contained inside. The insert assembly is removable to be replaced with a different insert assembly. The insert assemblies are widely variable and may, for example, have different colors or graphics, be reflective or iridescent, include lights or rattles and have a wiggling tail portion.

### BACKGROUND OF THE INVENTION

1. Field of the Invention

The present invention relates to fishing, and more particularly, to an artificial fishing lures that can be easily converted in character.

2. Description of the Related Art

Many designs for fishing lures have been designed in the past. None of them, however, includes a system where an angler can, without tools, quickly and easily change the character of a lure in any of a plurality of options.

Applicant believes that the closest reference corresponds to U.S. Pat. No. 6,108,960 issued to Sylla. However, it differs from the present invention because the present invention permits a nearly complete change of the lure without the necessity of re-tying the fishing line. Further, the present design allows not only chemical luminescence options but also total color and design change of the lure, rattles, scents, sheens and other desired characteristics. Further, the present invention does so without any moving parts which tend to corrode and fail in the harsh marine environment.

Other patents describe limited changeable parts in some fashion or another. However, these other patents that describe the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a fishing lure that is quickly and easily convertible in character.

It is another object of this invention to provide a fishing lure in which the nature of the lure can be fundamentally changed without the use of tools.

It is still another object of the present invention to provide a single lure that is used with many interchangeable elements so that space in the tackle box is conserved. In other words, only a hook-less portion of the lure, in is many varieties, is stored in number for each single hook carrying body.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

It should be noted that the invention is sometimes referred to as the device, the invention or the lure. Plural and singular are to be interpreted as appropriate for the context in light of the obvious intent and maximum flexibility of the design.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of a version of the device as, may be assembled for use.

FIG. 2 shows a perspective view of a body assembly without an insert assembly.

FIG. 3 illustrates a perspective view a version of an insert assembly.

FIG. 4 is a representation of elevation view of a variety of an insert assembly.

FIG. 5 is an elevation view of another embodiment of an insert assembly.

FIG. 6 is a side elevation view of yet another style of insert assembly.

FIG. 7 is a side elevation view of still another form of insert assembly.

FIG. 8 is a perspective view of another sort of insert assembly that is compatible with a body assembly similar to that as demonstrated in FIG. 9.

FIG. 9 is a perspective view of a version of a body assembly without an insert assembly.

FIG. 10 is a perspective view of a version of an insert assembly similar to that shown in FIG. 8.

FIG. 11 is a perspective view of the version of the body assembly as shown in FIG. 9.

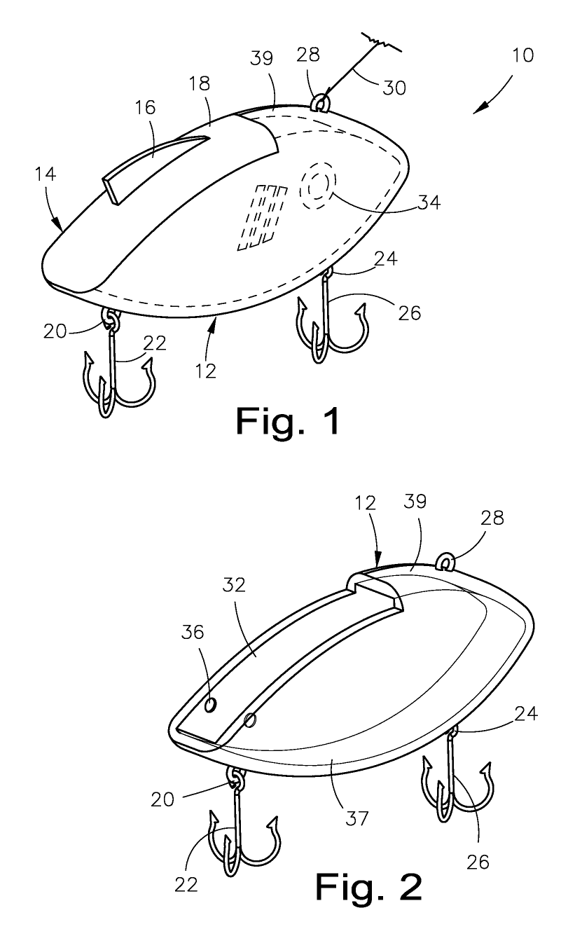

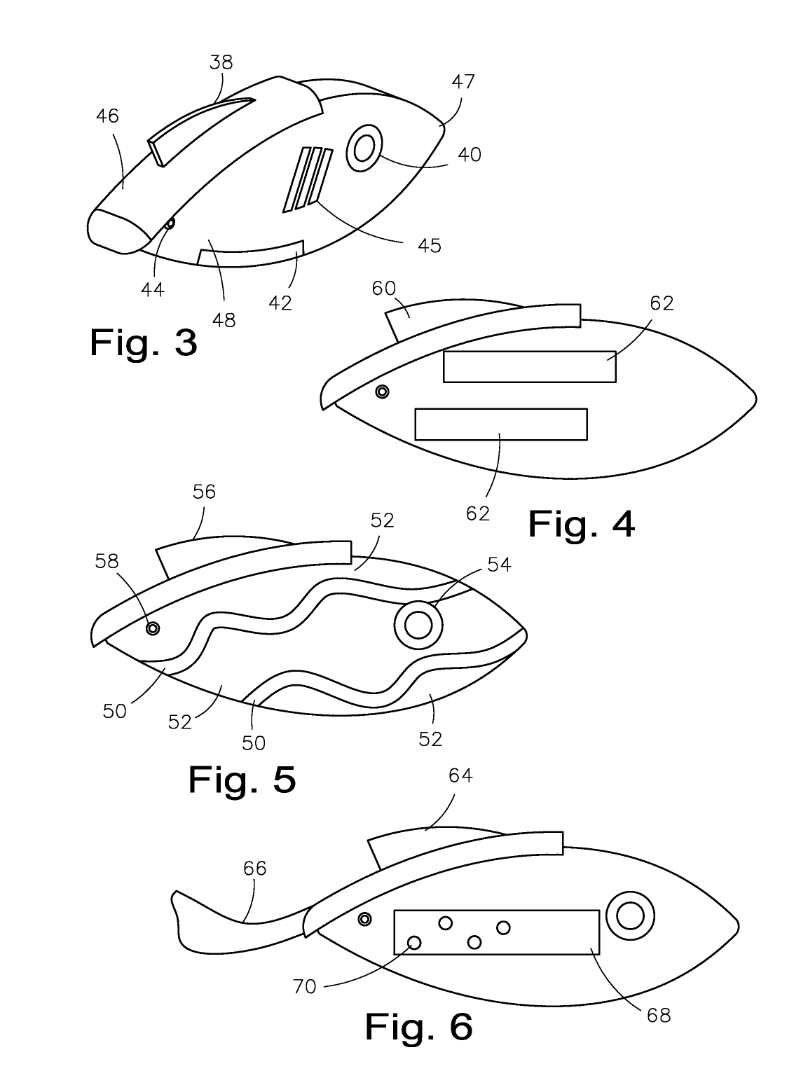

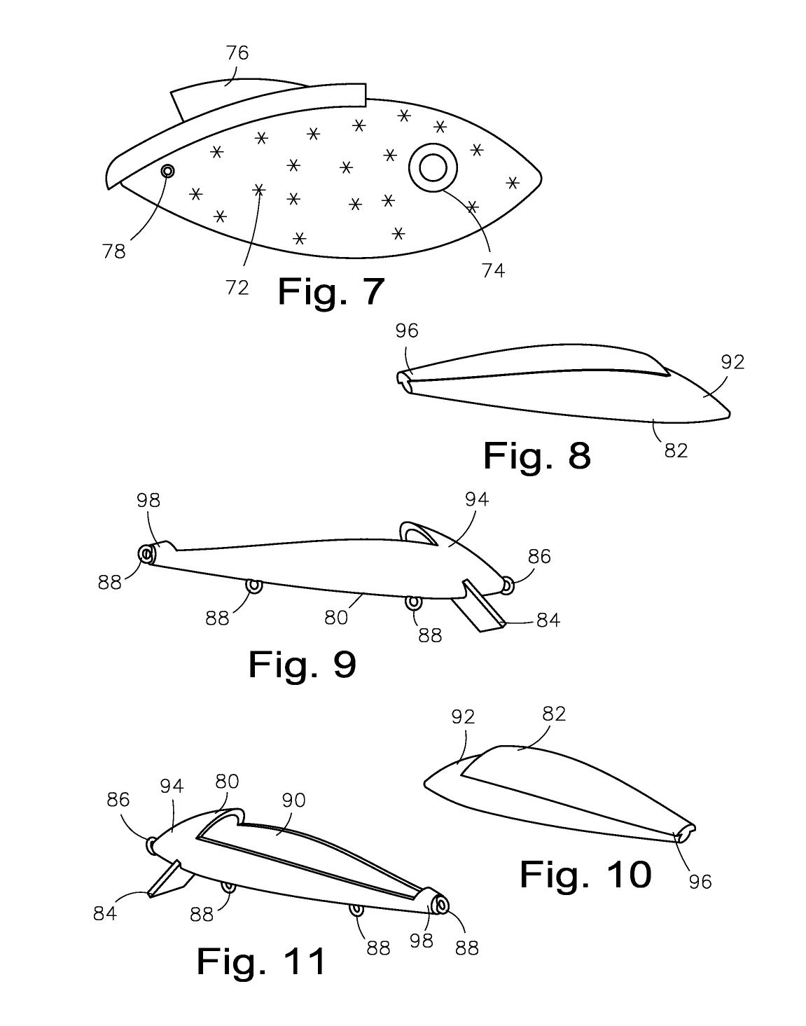

### DETAILED DESCRIPTION OF THE PREFERRED EMBODIMENT

Referring now to the drawings, where the present invention is generally referred to in figure one with numeral 10, it can be observed that it basically includes a body assembly 12 and an insert assembly 14. A line 30 is included in this figure for context and is not to be considered an element of the device.

As can be seen in the drawings at figures one through seven generally show one style of lure in several variations that include some combination of elements including, among other elements, a fin 16, an insert 18, an eyelet 20, a hook 22, an eyelet 24, a hook 26, an eyelet 28, a cavity 32, an eye 34, a dimple 36, a pectoral side 37, a fin 38, a dorsal side 39, an eye 40, a weight 42, a nub 44, gills 45, a back 46, a nose 47, a core 48, a stripe 50, a background 52, an eye 54, a fin 56, a nub 58, a fin 60, a light 62, a fin 64, a tail 66, a cavity 68, a rattle 70, a glitter 72, an eve 74, a fin 76 and a nub 78.

Generally, the body assembly 12, shown isolated in figure two, has a cavity 32 that is adapted for and dimensioned to fit the insert assembly 14 that is shown isolated in figure three. Figure one shows the insert assembly 14 fit inside the body assembly 12.

The body assembly 12 is configured to be tied to a fishing line 30 at the eyelet 28. In this regard the lure is similar to most other terminal tackle. The eyelet 28 is permanently anchored in an integrated into the body assembly 12.

An opening to the cavity 32 of the body assembly 12 is generally on the dorsal side 39. The hooks 22 and 26 are generally on the pectoral side 37. The eyelet 28 affixed to the line 30 on the dorsal side 39 along with the weight and drag in the water caused by the hooks 22 and 26 keep the lure in an upright orientation.

Similarly, the hook 22 is affixed to the body assembly 12 at eyelet 20. The hook 26 is also affixed to the body assembly 12 at eyelet 24. The positions of these hooks as shown in the drawings are merely examples of placement on the body assembly 12. There may be more or fewer hooks. They may be single or multiple hooks. There may be a split ring between the eyelet and hook to facilitate replacement of the hook if it should break or otherwise not work properly.

In typical use of the device is it normally infrequently necessary to untie and replace the body assembly 12. Instead, when the angler wishes to try a new presentation to the fish he may remove the insert assembly 14 from inside the body assembly 12 and replace it with a different variety of insert assembly 14.

The body assembly 12 is preferably constructed of a transparent material. This is primarily to allow the insert assembly 14 to be visible through the body assembly 12. Different tints of transparency may be beneficial in some environments. Similarly, a florescent tint may be preferred by some anglers. Generally, though, a clear plastic is best for the body assembly 12.

It is a main purpose of the invention to provide a variety of different insert assemblies 14. Some examples of how the insert assemblies 14 can vary are shown individually in figures three through seven. These illustrations are merely some of the different types of insert assembly 14 characteristic. It should be understood that any of these elements and features might be used individually or in combination. Further, other variations not depicted in the drawings may be used equally effectively and are to be understood to be included in the conceptual designs within the scope of the invention.

Figure three is one of these examples. This example of an insert assembly has an enlarged fin 38 that is integral to the back 46 element. The fin 38 can be used as a handle to aid the angler when inserting or removing the insert assembly 14 from the body assembly 12. The fin 38 may be a contrasting or similar color as the back 46.

Note the nub 44 on the aft end of this insert assembly. The nub 44 frictionally engages into the dimple 36 on the corresponding area of the body assembly 12. This helps the angler feel when the insert assembly 14 is positively snapped into the body assembly 12. It also helps keep the insert assembly 14 engaged into the body assembly 14 when dragged though the rigors of fishing. The nub 58 on figure five and the nub 78 on figure seven are analogous features to the nub 44 and equally engage into a corresponding divot 36 on a body assembly 12.

Referring again to figure three, an eye 40 decorates the side of the insert assembly 14 as well as a stylized gill 45 pattern. These graphics are visible through the transparent body assembly 12. These are but a couple of an infinite class of images that can adorn the side of the insert assembly 14. These visuals may or might not resemble a baitfish to entice a fish to attack or eat the lure.

A Figure three also includes an example of a weight 42 that is built into the insert assembly 14. In this example the weight is along the pectoral side towards the tail end of the core 48 of the insert assembly 14. This can act as a ballast weight to keep the lure upright and avoiding spinning while dragging through the water which can cause severe line twist, a problem experienced by many fisherman.

The inclusion of a weight 42 can be calculated to work with the density of the lure as a whole to cause the lure to present at a specified depth in the water column. In this way the angler can better control the presentation of the lure. For example, over a bottom surface with weeds or structure a lighter weight might be preferred so that the lure does not catch on those obstructions. In other scenarios where the water is deep and obstructions are absent then a heavier weight 42 might be preferred to bring the lure to the bottom.

The nose 47 leads when assembling the insert assembly 14 into the body assembly 12. The nose 47 helps align the insert assembly 14 into the body assembly 12. When the nose 47 is fully inserted then the nub 44 is pressed into the aft end of the body assembly 12 and is engaged into the divot 36 on the body assembly 12 where it is held, sufficiently by friction to avoid the risk of inadvertently disengaging during use in the water or while in storage.

Now referring to figure four where another vane of insert assembly is exhibited to include a pair of lights 62. Any number of lights 62 could be included as long as they fit in the insert assembly. Generally, the insert assembly in this version has cavities to snap the lights 62 into prior to mating with the body assembly 12. The lights 62 may be battery or chemically powered. For example, a cyalume or other types of chemiluminescence are effective. Various colors and combinations of glow provide benefit when used in low light conditions, whether at night or deep or murky water. The fin 60 may provide stability when pulled through the water.

Figure five is an example of an insert assembly 14 with a stylized eye 54. On this version a background 52 is tinted a contrasting or complementary color as the stripes 50. Any of the versions of any of the insert assemblies may generally be any color. Sometimes the color scheme is meant to mimic nature and other times it is preferred by the angler to be bright, stark colors to attract a game fish from a long distance away to entice a strike.

Figure six is yet another example of a version of an insert assembly 14 that includes a cavity 68 containing rattles 70. In this example the rattles 70 are essentially small spheres that loosely shake inside the cavity 68. The rattles 70 make noise while the lure moves through the water to provide an audible attractant to the target fish.

Figure six also has an example of an alternate tail 66. The tail 66 may provide some stability or may intentionally cause some instability. When the tail is made of a supple material, such as rubber or silicone, it can be shaped asymmetrically resulting in a wiggle and bouncing effect as the lure is pulled through the water. This can make the lure appear more life-like to the fish and increase the likelihood of a strike.

Figure seven is a stylized drawing of an insert assembly including a glitter 72 effect. The glitter 72 may be flecks of reflective, iridescent or luminescent bits that are integral to the insert assembly. The glitter 72 may look and shimmer like fish scales in a bait fish and may thereby increase the likelihood of a strike. The glitter 72 may be contrasting to the color of the balance of the insert assembly. The eye 74 may also include a reflective, glittery quality or may similarly be iridescent to provide contrast and an attractive sheen.

Figures eight through eleven show a similar device as seen in the earlier figures one through seven but with some variations. This version includes, among other features, a body assembly 80, an insert assembly 82, a bill 84, eyelets 86, an eyelet 88, a cavity 90, a nose 92, a nose 94, a tail 96 and a tail 98.

The principal variation in this version is the bill 84 on the leading edge of the body assembly 80 and the addition of another eyelet 88 in the middle of the pectoral side. The shape of this version is also a little more elongated than the prior version. It should be understood that the exact profile shape is not the core of the inventive concept. It is intended that any of a wide range of shapes based on the stylized appearance of bait fish may be equally employed.

The nose 92 of the insert assembly is pressed inside the nose 94 of the body assembly then the tail 96 is frictionally engaged into the tail 98 of the body assembly.

Any of the variations demonstrated for the earlier versions of the device, described supra and shown in the drawings may be equally applied to this version shown in figures eight through eleven. There is a plurality of eyelets 88 shown that are intended to support connection to a hook with or without an intervening split ring. The eyelet 86 may be affixed to the end of the fishing line.

The body assembly shown in figured nine and eleven are likewise preferably transparent and optionally clear to allow the insert assembly to be clearly seen while nested inside the body assembly. The size of the bill 84 may also be adjusted to compensate for a targeted dive depth of the lure.

The balance of the lure should also be carefully adjusted by the location or even inclusion of an additional weight. The net densities of the combined insert assembly and body assembly can also be adjusted with the inclusion of a weight to produce a select amount of buoyancy to float the lure at the correct depth.

An important variation of the device includes a decorative element integral to the body assembly either with or without a decorative element to the insert assembly. This body assembly decorative element can manifest in any of a tint, glitter, imitation gill marks, eyes, lines, scales, three dimensional textures (i.e. scales, eyes, gills or the like) or any of the other elements that have been described above as applied to an insert assembly. In this version of the device the insert assemblies might appear visually to be simply solid colors with the additional characteristics a part of the body assembly.

There are several additional contemplated means to secure an insert assembly into a body assembly either in place of or in addition to the nub and dimple combination as described above. For example, a magnet may be embedded into the forward end of the insert assembly or the forward end of the body assembly, either with a corresponding magnet attracting element in the opposing piece to hold the body assembly and insert assembly together. Magnets may be placed in other strategic positions to magnetically adhere the insert assembly to the body assembly while the lure is in use.

In yet another possible variation of means to hold the insert assembly into the body assembly there may be a spring between the insert assembly and body assembly that acts with a wedge to hold the two pieces together. The user may the press the parts together to unhook from the wedge to separate the insert assembly from the body assembly. Other means such as a pin or clip may equally be used to secure the body assembly over the insert assembly and yet allow easy disconnection by the angler to swap out insert assemblies.

The invention can be fairly described as a fishing lure comprised, of a body assembly and an insert assembly. The body assembly has an eyelet on forward end adapted for attachment to a fishing line. The line is typically clipped or tied to this eyelet. On the other end the body assembly has integrally attached at least one eyelet adapted for attachment to a fishing hook. In an important version the body assembly is transparent to permit the insert assembly to be visible through the body assembly. The body assembly has a generally hollow interior that is dimensioned to frictionally hold inside said insert assembly. Alternatively a spring or clip means can hold or help hold the insert assembly into the body assembly. The insert assembly includes a predetermined decoration that is visible through the body assembly when said insert assembly is fit inside said body assembly. This can be fish-like markings, lights, patterns, dazzling glitter or other visual character intended to entice a fish to attack or eat the device and get caught on the hook.

Important variations can include a bill is affixed on a nose of the body assembly. This can affect the action and dive depth of the lure as well as add an aesthetic dimension. Optionally the insert assembly has any of a rattle, a light or a weight to get the attention of the prey. In addition to or alternatively to other characteristics the insert assembly or the body assembly can include a surface that has glitter, iridescence or fluorescence. To aid in keeping the insert assembly into the body assembly the insert assembly has a nub at the tail end that frictionally engages a corresponding divot at an interior and a tail end of said body assembly. Obviously the nub could be on the body assembly and the divot could be on the insert assembly and remain effective. Alternatively or in combination with other means include a magnet and a magnet attracting element are provided to aid in maintaining the connection between the body assembly and the insert assembly, effectively sticking them together. Another means to aid in securing the pieces together can be characterized in that a spring and a wedge element are included to aid in maintaining the connection between the body assembly and the insert assembly. In yet other versions, with or without other elements, the body assembly can include any of the decorative or attractive elements that have been described to be included on the insert assembly.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A fishing lure comprised, of a body assembly and an insert assembly;
said body assembly has an eyelet on forward end adapted for attachment to a fishing line;
said body assembly has integrally attached at least one eyelet adapted for attachment to a fishing hook;
said body assembly is transparent;
the body assembly has a generally hollow interior;
said hollow interior is dimensioned to frictionally hold inside said insert assembly;
said insert assembly includes a predetermined decoration that is visible through the body assembly when said insert assembly is fit inside said body assembly.

2. A fishing lure as disclosed in claim 1 further characterized in that a bill is affixed on a nose of the body assembly.

3. A fishing lure as disclosed in claim 1 further characterized in that said insert assembly has any of a rattle, a light or a weight.

4. A fishing lure as disclosed in claim 1 further characterized in that said insert assembly is includes a surface that has glitter, iridescence or fluorescence.

5. A fishing lure as disclosed in claim 1 further characterized in that said insert assembly has a nub at a tail end that frictionally engages a corresponding divot at an interior and a tail end of said body assembly.

6. A fishing lure as disclosed in claim 1 further characterized in that a magnet and a magnet attracting element are included to aid in maintaining the connection between the body assembly and the insert assembly.

7. A fishing lure as disclosed in claim 1 further characterized in that a spring and a wedge element are included to aid in maintaining the connection between the body assembly and the insert assembly.

8. A fishing lure as disclosed in claim 1 further characterized in that said body assembly includes a decorative element.
